(19) United States
(12) Patent Application Publication
(10) Pub. No.: US 2016/0237958 A1
(43) Pub. Date: Aug. 18, 2016

(54) Magnetic Filter Containing Nanoparticles Used for Saving Fuel in a Combustion Chamber

(71) Applicant: Awad Rasheed Suleiman Mansour, Chicago Ridge, IL (US)

(72) Inventor: Awad Rasheed Suleiman Mansour, Chicago Ridge, IL (US)

(21) Appl. No.: 15/010,789

(22) Filed: Jan. 29, 2016

(30) Foreign Application Priority Data
Feb. 13, 2015 (EP) 1515494.2

(51) Int. Cl. F02M 27/04; B03C 1/01

(52) U.S. Cl. CPC F02M 27/04; B03C 1/01

(57) ABSTRACT

The present invention relates to a magnetic component for efficient burning of a fluid fuel in a combustion chamber comprising a magnetizing material and nanoparticles comprising oxides of zinc, aluminum and magnesium. In preferred embodiments, said magnetizing material is a magnetic filter comprising Neodymium-Iron-Boron (NdFeB) magnet and said nanoparticles comprise ZnO, Al₂O₃ and MgO.

### CROSS-REFERENCE TO RELATED APPLICATION

This application claims priority to European Application No. 1515494.2, filed Feb. 13, 2015, the disclosure of which is incorporated herein by reference in its entirety.

### TECHNICAL FIELD OF THE INVENTION

The present invention relates to magnetic components for increasing efficiency of a combustion chamber operated with hydrocarbon fuels, and more particularly the invention pertains to a novel magnetic filter comprising magnetizing materials and nanosized particles for conditioning the hydrocarbon fuel used in an internal combustion engine.

### BACKGROUND OF THE INVENTION

It is known that burning efficiency of the combustion chambers such as internal combustion engines is in very low level such that the combustion is carried out inefficiently and inappropriately with incomplete and falsified burning reactions producing unburned hydrocarbons (HC), carbon monoxide (CO) and oxides of nitrogen (NOₓ). Unburned HC and NOx react in the atmosphere to form photo-chemical smog. Smog is highly oxidizing in the environment and is the prime cause of eye and throat irritation, bad odor, plant damage, and decreased visibility. Oxides of Nitrogen are also toxic. CO impair blood capability to carry oxygen to the brain, resulting in slower reaction times and impaired judgement.

Generally a liquid fuel used for an internal combustion engine is composed of a set of molecules. Each molecule includes a number of atoms, which is composed of a nucleus and electrons orbiting around their nucleus. The molecules have magnetic moments in themselves, and the rotating electrons cause magnetic phenomena. Thus, positive (+) and negative (−) electric charges exists in the fuel's molecules. For this reason, the fuel particles of the negative and positive electric charges are not split into more minute particles. Accordingly, the fuels are not actively interlocked with oxygen during combustion, thereby causing incomplete combustion. To improve the above, the fuels have been required to be decomposed and ionized. The term “ionization” implies that the fuel acquires a charge and molecules of like charge repel each other, which makes fuel dispersal more efficient.

There are plenty of attempts to modify the molecular arrangement and to ensure ionization of liquid fuels in internal combustion engines for improving efficiency of the burning process. One of the oldest and very popular one is placing a polarized material such as a magnet around the periphery of a fuel conduit before an engine or any combustion chamber so that an electrical field is created for modifying the fuel molecules. It is believed that groupings of hydrocarbons, when flowing through a magnetic field, change their orientations of magnetization in a direction opposite to that of the magnetic field. The molecules of hydrocarbon change their configuration. At the same time intermolecular force is considerably reduced or depressed by the effect of nanoparticles. These mechanisms are believed to help to disperse oil particles and to become finely divided. In addition, hydrogen ions in fuel and oxygen ions in air or steam are magnetized to form magnetic domains which are believed to assist in atomizing fuel into finer particles.

As an Example, U.S. Pat. No. 3,830,621, U.S. Pat. No. 4,188,296, U.S. Pat. No. 4,461,262, U.S. Pat. No. 4,572,145, U.S. Pat. No. 5,331,807, U.S. Pat. No. 5,664,546 disclose magnetizing assemblies for the purposes set forth above which generally include a magnet, South pole of which is brought in close proximity with a fuel line so that the fuel molecules are reorganized for improving the burning efficiency. The magnetizing material is placed onto various components of a combustion system with different arrangements, however, the effect of these systems is mostly quite limited because the magnetic field as such is mostly insufficient for ionization and conditioning of the fuel molecules in a closed conduit system. It is known that density of an electrical field imposed to a flowing liquid fuel is affected by many parameters such as the power of the magnetizer, its distance to the fuel per se and even the material and the thickness of the housing or conduit of the fuel.

Therefore, the present invention solves a long felt need in this area by elimination of the problems encountered in fuel saving arrangements, with a system comprising magnetizing materials and nanosized particles according to the appended claims.

### SUMMARY OF THE INVENTION

The present invention provides a magnetic component for efficient burning of a fluid fuel in a combustion chamber comprising a magnetizing material and nanoparticles comprising oxides of zinc, aluminum and magnesium. In preferred embodiments, said magnetizing material comprises a Neodymium-Iron-Boron (NdFeB) magnet and the said nanoparticles comprise ZnO, Al₂O₃ and MgO and have particle sizes less than 500 nm, more preferably between 10 and 100 nm.

In preferred embodiments the nanoparticles can be placed into a tablet that can be brought into physical contact with the fuel in a fuel supply system of the combustion chamber. In these embodiments the magnetizing material can be provided as a shell in the periphery of said tablet. The south pole of the magnet is arranged in close proximity to the nanoparticles while the North pole is spaced apart therefrom. In another embodiment, the magnetic component according to present invention is in the form of a fuel filter whereby the said nanoparticles are arranged in fuel passageways to provide a direct contact with said fuel.

The magnetizing material as defined herein can be provided in physical contact with the nanoparticles. The magnetic component according to the present invention can be placed onto a fuel supply line of the combustion chamber such that the nanoparticles are brought into physical contact with the fuel. The combustion chamber is preferably an internal combustion engine and the invention is found to have a particular effect if said fuel is gasoline.

### DETAILED DESCRIPTION OF THE INVENTION

Technical problem to be solved by the present invention is to find a fast assistant, which will accelerate ignition process, improve hydrocarbon combustion and prevent detonation, burning coke, in order the engine produces maximum efficiency, and saves gasoline consumption and reduces exhaust emissions.

These objects are achieved through a combined system comprising a magnetic material and energetic nanoparticles which are found to be producing a very effective synergistic outcome if they are used together to modify a liquid fuel before usage in a combustion chamber. The system mentioned above is aimed to be used in any combustion chamber like internal combustion engines utilizing of liquid fuels, particularly gasoline. The system can be placed on any component in a fuel supplying assembly such as the conduits, fuel pumps, filters and in a place before/after mixing chambers such as fuel injectors or carburettors.

The magnetic material according to the present invention comprises Neodymium Iron Boron (NdFeB) which is also known as a neodymium magnet in the market. As every magnet known in the state of the art, this magnetizing material shall be possessing polarized features having a South and North pole. In the context of the present invention, it is aimed to place the South pole in a close proximity of the liquid fuel in a fuel supply line. The magnetic material is preferably selected to have a magnetic field strength higher than 11.000 Gauss.

Energetic nanoparticles according to the present invention are provided as a mixture of the elements oxides of the elements comprising Zinc, Aluminum and Magnesium. In the context of the present invention, the term nanoparticle refers to small particles having a particle size less than 500 nm and more particularly between 10 and 100 nm. The proportion of each oxide in the mixture can be any value and even trace amounts produce the desired effect. Nevertheless, proportions of each oxide substantially equal to the others would be preferable. Such proportions can be arranged depending on the fuel type or costs of the oxides independently.

The inventor of the current invention unexpectedly found that the energetic nanoparticles as defined hereinabove behave as a catalyst if they are used in combination with magnetizing material as described herein. The catalysing effect of the nanoparticles greatly enhances ionization of the fuel molecules and reorganization thereof especially in a flowing fuel system by virtue of the passivated oxide layers characterized by a high rate of energy release. In particular, energetic nanoparticles offer a high volumetric heat of oxidation, enabling transportation of more energy per given fuel volume. When mixed in a fuel or a composite, they generally exhibit faster ignition timescales due to the dramatic increase in the surface-to-volume ratio, and can ignite below the bulk melting point of the metal due to rapid temperature gradients through their thin oxide layers. Nano-sized energetic particles offer the potential of controlled burning rates, increased combustion efficiencies, and reduced sensitivity.

Therefore, the magnetic components comprising a magnetizing material and the nanoparticles according to the present invention are arranged such that the said nanoparticles are arranged in a device in fluid communication with the liquid fuel. Due to this direct contact with the fluid, the magnetizing power and the electrical field created by the magnetizing material is directly transferred to the fuel molecules without the limitations of the systems in prior art. Therefore, the magnetic component according to the instant invention is embodied as a fuel filter whereby the nanoparticles arranged in fluid communication with the liquid fuel and the magnetizing material is provided in a shell. Alternatively, the magnetic component can be arranged as a device wherein nanoparticles are provided in a tablet and the magnetizing material can be provided in a Shell. In this arrangement, said tablets are arranged in a replaceable manner.

The nanoparticles according to this invention do not dissolve in hydrocarbon fuel, and therefore they offer a long term run in a particular device such as a filter as mentioned above. In particular embodiments of the present invention, there is no need to provide said nanoparticles in physical contact with the magnetizing material because the said nanoparticles may well transfer the electrical field to the liquid fuel and catalyse the same. Nevertheless, it would be preferable to provide this physical contact in an integrated device for obtaining the electrical field with the desired strength.

In preferred embodiments of the present invention, the oxides of zinc, aluminum and magnesium comprised in the nanoparticles as described herein are zinc oxide (ZnO), alumina (Al₂O₃) and magnesia (MgO), respectively.

By virtue of the enhanced magnetic field transfer in molecular level, the fuel is dispersed into more tiny particles and becomes less viscous. The resultant conditioned fuel/air mixture as magnetized herein burns more completely, producing higher engine output, better fuel economy, more power and most importantly reduces the amount of hydrocarbons, carbon monoxide and oxides of nitrogen in the exhaust. Another benefit of these components is that magnetically charged fuel molecules with opposite polarities dissolve carbon build-up in carburettor jets, fuel injectors, and combustion chambers, and they help to clean up the engine and maintain its clean condition.

The inventor of the present invention has surprisingly found that the combined system according to the instant invention can produce the effects of making combustion almost complete (with unburned hydrocarbon less than 20 ppm), lowering gas consumption up to 65%, burning out carbon deposit, reducing gas pollution especially carbon monoxide (CO) which is reduced down to 0.0%, and increasing engine performance drastically.

### EXAMPLE

A filter arrangement comprising the magnetizing material (NdFeB) as a shell and the nanoparticles (a mix of oxides of Zn, Al, and Mg) having a particle size arrangement between 10 and 100 nm contained in a tablet is placed into a fuel conduit supplying gasoline to the fuel injectors in automobiles of different brands.

The automobiles are tested in identical conditions with constant speed in the same route.

Following are the fuel saving results of each automobile tested in the procedure:

| Automobile | Fuel saving (%) |
|---|---|
| 1995 Hyundai Avante (1.5 liter | 50 |
| engine) | |
| 2012 Toyota Camry | 43 |
| 2006 Mitsubishi Lancer | 45 |
| 2000 Kia | 55 |
| 2001 Mercedes (1.8 liter engine) | 45 |
| 1998 Opel Omega (3.0 liter engine) | 51 |
| 2006 Mazda (2.0 liter engine) | 63 |

### Emission

2006 Mazda (2.0 liter engine) mentioned above was tested by measuring the exhaust gases. The results were as follows:

Carbon Monoxide (CO): 0.0%

HC (Hydrocarbon): 29 ppm

CO₂: 14.8%

O₂: 0.07%

H/C: 1.85

1. A magnetic component for efficient burning of a fluid fuel in a combustion chamber comprising a magnetizing material and nanoparticles comprising oxides of zinc, aluminum and magnesium.

2. The magnetic component according to claim 1 wherein said magnetizing material comprises a Neodymium-Iron-Boron (NdFeB) magnet.

3. The magnetic component according to claim 1 wherein the nanoparticles comprise ZnO, Al₂O₃ and MgO.

4. The magnetic component according to claim 3 wherein said nanoparticles have particle sizes between 10 nm and 100 nm.

5. The magnetic component according to claim 1 wherein said nanoparticles are placed into a tablet that can be brought into physical contact with the fuel in a fuel supply system.

6. The magnetic component according to claim 5 wherein the magnetizing material is provided as a shell in the periphery of said tablet.

7. The magnetic component according to claim 6 wherein south pole of the magnet is arranged in close proximity to the nanoparticles while the north pole is spaced apart therefrom.

8. The magnetic component according to claim 1 in the form of a fuel filter whereby the said nanoparticles are arranged in fuel passageways to provide a direct contact with said fuel.

9. A magnetic component according to claim 1 wherein the magnetizing material is provided in physical contact with the nanoparticles.

10. A method for improving burning in a combustion chamber comprising placing the magnetic component according to any of the preceding claims onto a fuel supply line of the combustion chamber such that the nanoparticles are brought into physical contact with the fuel.

11. A method according to claim 10 wherein said combustion chamber is an internal combustion engine.

12. A method according to claim 11 wherein the fuel is gasoline.

13. A method according to claim 12 wherein the nanoparticles are arranged within a tablet or fuel filter and the magnetizing material is provided as a shell around the periphery of said tablet or filter.

14. A method according to claim 13 wherein said magnetizing material comprises Neodymium-Iron-Boron (NdFeB) magnet and said nanoparticles comprise ZnO, Al₂O₃ and MgO.
